(19) United States
(12) Patent Application Publication
(10) Pub. No.: US 2012/0085188 A1
(43) Pub. Date: Apr. 12, 2012

(54) NONCIRCULAR BEARING, WAVE GENERATOR, AND WAVE GEAR DEVICE

(75) Inventor: Junichi Kurogi, Nagano (JP)

(73) Assignee: Harmonic Drive Systems Inc., Tokyo (JP)

(21) Appl. No.: 13/377,161

(22) PCT Filed: Jul. 2, 2009
(86) PCT No.: PCT/JP2009/003085

§ 371 Date: Dec. 9, 2011

(51) Int. Cl. F16C 33/58; F16H 35/00

(52) U.S. Cl. 74/411; 384/513

(57) ABSTRACT

A wave generator (4) of a wave gear device (1) is equipped with a rigid cam plate (5) and a wave bearing (7). The wave bearing (7) comprises an oval raceway surface (5b) formed on the oval outer peripheral surface (5a) of the rigid cam plate (5), a flexible bearing ring (8) equipped with a circular raceway surface (8a), and multiple balls (10) inserted in the race (9) formed between oval raceway surface (5b) and circular raceway surface (8a). A ball insertion hole (11) is formed at the outer perimeter edge of the rigid cam plate (5) at a region above the minor axis Lmin of the oval where there is substantially no load; from here, the balls (10) are inserted into the race (9), after which the hole is closed by a plug (12). It is easy to insert the balls (10) through the ball insertion hole (11), and the service life of the bearing is not reduced since the ball insertion hole (11) is formed.

### TECHNICAL FIELD

The present invention relates to a noncircular bearing including a rigid raceway member that has a noncircular raceway surface, an annular flexible raceway ring that is flexible in the radial direction, and a plurality of rolling elements that are inserted between the rigid raceway member and the flexible raceway ring and cause the flexible raceway ring to flex into a noncircular shape. The present invention particularly relates to a rolling element insertion structure through which the rolling elements are inserted into the space between the rigid raceway member and the flexible raceway ring. The present invention further relates to a wave generator provided with a wave bearing having the rolling element insertion structure and used in a wave gear device, and to a wave gear device provided with the wave generator.

### BACKGROUND ART

Some ball bearings and other similar bearings are known as flexible ball bearings, in which balls are inserted between a flexible outer ring and a flexible inner ring that are flexible in the radial direction. A flexible ball bearing of this type is used as a wave bearing in a wave generator of a wave gear device.

A wave gear device typically includes an annular rigid internally toothed gear, an annular flexible externally toothed gear disposed inside the internally toothed gear and concentrically therewith, and a wave generator having an oval contour and fit in the externally toothed gear. The wave generator includes a rigid cam plate having an oval outer peripheral surface and a wave bearing mounted on the oval outer peripheral surface of the rigid cam plate. The rigid cam plate flexes a flexible outer ring and a flexible inner ring of the wave bearing into oval shapes, and in this state, balls are rollably inserted between the outer and inner rings.

The wave bearing flexed by the rigid cam plate into an oval shape is disposed between the rigid cam plate and the flexible externally toothed gear, which can therefore be rotated relative to each other. The flexible externally toothed gear flexed into an oval shape is in contact with the circular rigid internally toothed gear, and external teeth on both sides of the major axis of the oval of the externally toothed gear mesh with the corresponding internal teeth of the internally toothed gear. The rigid cam plate is connected to a motor output shaft or any other rotating shaft. When the rigid cam plate is rotated, the positions where the flexible externally toothed gear meshes with the rigid internally toothed gear move in the circumferential direction, and relative rotation according to the difference in the number of teeth between the two gears is produced therebetween. Patent Document 1 (Japanese Patent Application Laid-Open No. 11-351341) proposes an inventive oval contour shape of a rigid cam plate in a wave generator.

In a wave bearing flexed by an oval rigid cam plate into an oval shape, the load acting on each ball changes with its position in the circumferential direction, as described in Patent Document 2 (Japanese Patent Application Laid-Open No. 2009-41655).

That is, in a typical annular ball bearing, the loads acting on the balls in all positions in the circumferential direction are the same, whereas in an oval wave bearing, in which the rigid cam plate forcibly flexes the flexible raceway ring outward in the radial direction in both end positions in the major axis direction of the oval, the balls in both the end positions are so sandwiched between the flexible raceway rings that the balls are held tight or locked and prevented from rolling. In contrast, in both end positions in the minor axis direction of the oval, where there is a large space between the flexible raceway rings, the balls are so sandwiched that they are held loose. The thus configured wave bearing, after assembled in the same manner as a typical ball bearing including annular rigid raceway rings, is mounted on the oval outer peripheral surface of the rigid cam plate.

There is another known wave gear device including a wave generator having a noncircular contour other than an oval contour. For example, in a wave generator called a three-lobe type, a flexible externally toothed gear is flexed so that it meshes with a rigid internally toothed gear in three positions in the circumferential direction.

### PRIOR ART DOCUMENT

### Patent Document

Patent Document 1: Japanese Patent Application Laid-Open No. 11-351341

Patent Document 2: Japanese Patent Application Laid-Open No. 2009-41655

### DISCLOSURE OF THE INVENTION

### Problems to be Solved by the Invention

To reduce the number of parts of a wave bearing and to simplify the assembly thereof, it is conceivable to form the inner ring of the wave bearing integrally with the oval outer peripheral surface of the rigid cam plate. In an oval bearing of this type, it is necessary to assemble a thin annular flexible outer ring in such a way that it surrounds the oval raceway surface formed along the oval outer peripheral surface of the rigid cam plate and insert balls between the flexible outer ring and the oval raceway surface.

In this case, since the inserted balls cause the annular flexible outer ring to flex into an oval shape according to the oval shape of the rigid cam plate, the greatest gap between the rigid cam plate and the flexible outer ring decreases as the flexible outer ring is flexed by inserting the balls into an oval shape. In view of this fact, when the inner ring is formed integrally with the rigid cam plate, there is a problem of an extreme difficulty in inserting the balls. The same problem occurs when the inner ring of a wave bearing is formed integrally with the rigid cam plate having a noncircular outer peripheral surface instead of an oval outer peripheral surface.

In view of the points described above, an object of the present invention is to propose a noncircular bearing provided having a rolling element insertion structure that allows balls or any other rolling elements to be readily inserted.

Another object of the present invention is to propose a noncircular bearing having a rolling element insertion structure that does not cause any decrease in service life of the bearing resulting from flaking or any other similar problem.

Still another object of the present invention is to propose a wave generator using the new noncircular bearing as a wave bearing and used in a wave gear device.

Still another object of the present invention is to propose a wave gear device including the wave generator using the new noncircular bearing as a wave bearing.

### Means Used to Solve the Above-Mentioned Problems

To achieve the objects described above, a noncircular bearing according to the present invention is characterized in comprising:

a rigid raceway member having a noncircular raceway surface;

a flexible raceway ring that is flexible in a radial direction and has a circular raceway surface before it is flexed;

a plurality of rolling elements rollably inserted into a race formed between the noncircular raceway surface and the circular raceway surface;

an insertion hole formed in the rigid raceway member to insert the rolling elements into the race; and

a plug that blocks the insertion hole,

wherein the flexible raceway ring is flexed by the rolling elements inserted into the race and the circular raceway surface thereof is flex into a shape similar to a shape of the noncircular raceway surface, and

the noncircular shape of the noncircular raceway surface is defined by a closed curve inscribable in or circumscribable about a perfect circle at evenly spaced multiple locations along a circumferential direction of the perfect circle.

In the noncircular bearing according to the present invention, the rolling elements are inserted through the insertion hole. Therefore, even after the inserted rolling elements cause the flexible raceway ring to flex and hence the greatest width of the race between the flexible raceway ring and the rigid raceway member narrows, the remaining rolling elements can be readily inserted. The process of inserting the rolling elements can therefore be readily performed, as in the case of a typical annular bearing.

When the noncircular raceway surface is formed along an outer peripheral surface of the rigid raceway member, and the circular raceway surface is formed along an inner peripheral surface of the flexible raceway ring, the noncircular shape of the noncircular raceway surface is defined by a closed curve inscribable in a perfect circle.

In this case, the insertion hole is desirably formed in a position offset in the circumferential direction from an inscribed position where the closed curve that defines the noncircular raceway surface is inscribed in a perfect circle.

When a torque is transferred via a noncircular bearing, the largest load acts on the inscribed location described above. In this case, forming the insertion hole at the inscribed location disadvantageously forms a seam resulting from the insertion hole on the raceway surface part, possibly resulting in flaking or other problems, and hence a decrease in service life of the bearing. It is therefore desirable to form the insertion hole in a position offset in the circumferential direction from the inscribed location where a large load acts.

When the noncircular raceway surface is an oval raceway surface, the insertion hole is desirably formed in a position offset in the circumferential direction from the major axis of an oval that defines the oval raceway surface. In general, the insertion hole is desirably formed in a position within a range of 90 degrees in the circumferential direction centered on the minor axis of the oval that defines the oval raceway surface. In particular, the insertion hole is desirably formed in a position on the minor axis of the oval that defines the oval raceway surface.

Conversely, when the noncircular raceway surface is formed along an inner peripheral surface of the rigid raceway member, and the circular raceway surface is formed along an outer peripheral surface of the flexible raceway ring, the noncircular shape of the noncircular raceway surface is defined by a closed curve circumscribable about a perfect circle.

In this case, the insertion hole is desirably formed in a position offset in the circumferential direction from a circumscribed position where the closed curve that defines the noncircular raceway surface is circumscribed about the perfect circle.

When the noncircular raceway surface is an oval raceway surface, the insertion hole is desirably formed in a position offset in the circumferential direction from the minor axis of an oval that defines the oval raceway surface. Further, the insertion hole is desirably formed in a position within a range of 90 degrees in the circumferential direction centered on the major axis of an oval that defines the oval raceway surface. In particular, the insertion hole is desirably formed in a position on the major axis of an oval that defines the oval raceway surface.

According to the present invention, there is provided a wave generator of a wave gear device in which a flexible gear is flexed into a noncircular shape so that the flexible gear partially meshes with a rigid gear and a position where the two gears mesh with each other is moved in a circumferential direction so that relative rotation according to the difference in the number of teeth between the two gears is produced therebetween, the wave generator characterized in comprising:

a rigid cam plate and a wave hearing,

wherein the wave bearing includes

a noncircular raceway surface formed on the rigid cam plate,

a flexible raceway ring that is flexible in a radial direction and has a circular raceway surface before it is flexed,

a plurality of rolling elements rollably inserted into a race formed between the noncircular raceway surface and the circular raceway surface,

an insertion hole formed in the rigid raceway member to insert the rolling elements into the race, and

a plug that blocks the insertion hole,

wherein the flexible raceway ring is flexed by the rolling elements inserted into the race and the circular raceway surface thereof is flex into a shape similar to a shape of the noncircular raceway surface, and

the noncircular shape of the noncircular raceway surface is defined by a closed curve inscribable in or circumscribable about a perfect circle at evenly spaced multiple locations along a circumferential direction of the perfect circle.

When the rigid gear is a rigid internally toothed gear, the flexible gear is a flexible externally toothed gear, and the wave generator is disposed inside the flexible externally toothed gear, the noncircular raceway surface is formed along an outer peripheral surface of the rigid cam plate, and the circular raceway surface is formed along an inner peripheral surface of the flexible raceway ring. In this case, the noncircular shape of the noncircular raceway surface is desirably defined by a closed curve inscribed in a perfect circle, and the insertion hole is desirably formed in a position offset in the circumferential direction from an inscribed position where the closed curve that defines the noncircular raceway surface is inscribed in the perfect circle.

When the noncircular raceway surface is an oval raceway surface, the insertion hole is desirably formed in a position offset in the circumferential direction from the major axis of an oval that defines the oval raceway surface. Further, the insertion hole is desirably formed in a position within a range of 90 degrees in the circumferential direction centered on the minor axis of an oval that defines the oval raceway surface. In particular, the-insertion hole is desirably formed in a position on the minor axis of an oval that defines the oval raceway surface.

Conversely, when the rigid gear is a rigid externally toothed gear, the flexible gear is a flexible internally toothed gear, the flexible internally toothed gear is disposed inside the wave generator, the noncircular raceway surface is formed along an inner peripheral surface of the rigid cam plate, and the circular raceway surface is formed along an outer peripheral surface of the flexible raceway ring, the noncircular shape of the noncircular raceway surface is desirably defined by a closed curve circumscribable about a perfect circle, and the insertion hole is desirably formed in a position offset in the circumferential direction from a circumscribed position where the closed curve that defines the noncircular raceway surface is circumscribed about the perfect circle.

When the noncircular raceway surface is an oval raceway surface, the insertion hole is desirably formed in a position offset in the circumferential direction from the minor axis of an oval that defines the oval raceway surface. Further, the insertion hole is desirably formed in a position within a range of 90 degrees in the circumferential direction centered on the major axis of an oval that defines the oval raceway surface. In particular, the insertion hole is desirably formed in a position on the major axis of an oval that defines the oval raceway surface.

According to the present invention, there is provided a wave gear device comprising: a rigid gear; a flexible gear disposed concentrically with the rigid gear; and a wave generator that flexes the flexible gear into a noncircular shape to allow the flexible gear to partially mesh with the rigid gear and moves the position where the two gears mesh with each other in a circumferential direction to produce relative rotation between the two gears in accordance with the difference in the number of teeth between the two gears, characterized in that the wave generator is provided with the wave bearing configured as described above.

### Effect of the Invention

In any of the noncircular bearings according to the present invention, the rolling elements are inserted through the insertion hole. Therefore, even after inserted rolling elements cause the flexible raceway ring to flex into a noncircular shape and hence the width of the race between the flexible raceway ring and the rigid raceway member narrows, the remaining rolling elements can be readily inserted. The process of inserting the rolling elements can therefore be readily performed, as in the case of a typical annular bearing.

Further, in any of the noncircular bearings according to the present invention, the insertion hole is formed in a position shifted from a position where a large load acts or in a position where substantially no load acts. Therefore, flaking or any other similar problem resulting from a step produced in the position where the insertion hole is formed on the noncircular raceway surface will not occur, whereby the service life of the bearing will not decrease.

### BRIEF DESCRIPTION OF THE DRAWINGS

FIG. 1 is a schematic longitudinal cross-sectional view showing a wave gear device according to a first embodiment of the present invention;

FIG. 2 is a descriptive diagram showing a meshing state of the wave gear device of FIG. 1;

FIG. 3 is a front view showing a wave generator of the wave gear device of FIG. 1;

FIG. 4 is a partial cross-sectional view showing the portion of the wave generator of FIG. 3 where a ball insertion hole is formed;

FIG. 5 is a descriptive diagram showing a wave gear device according to a second embodiment of the present invention;

FIG. 6 is a descriptive diagram showing a wave gear device according to a third embodiment of the present invention; and

FIG. 7 is a descriptive diagram showing a wave gear device according to a fourth embodiment of the present invention.

### MODE FOR CARRYING OUT THE INVENTION

Embodiments of a wave gear device to which the present invention is applied will be described below with reference to the drawings.

### First Embodiment

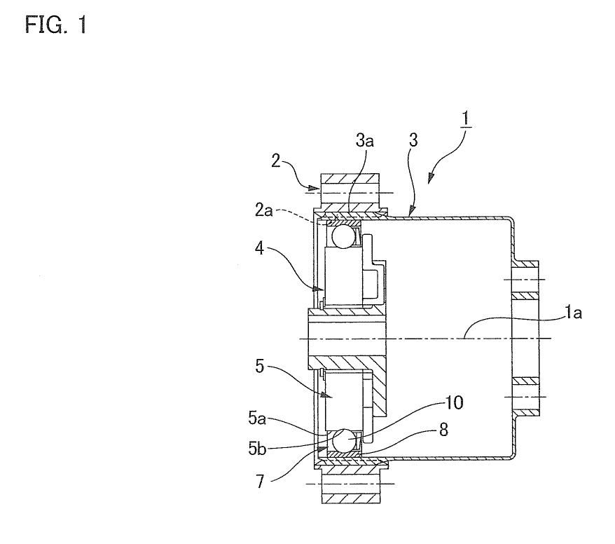

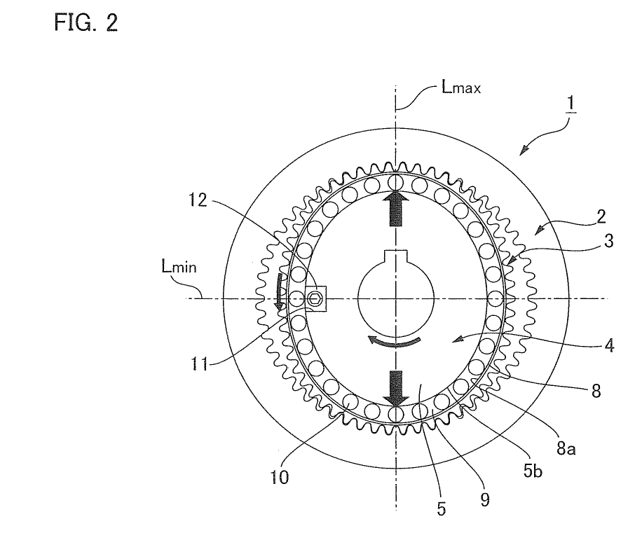

FIG. 1 is a longitudinal cross-sectional view of a wave gear device according to a first embodiment, and FIG. 2 is a schematic diagram showing a meshing state of the wave gear device. A wave gear device 1 includes a rigid internally toothed gear 2, a flexible externally toothed gear 3 having a cup shape and disposed in the rigid internally toothed gear 2, and a wave generator 4 having an oval contour and fit in the flexible externally toothed gear 3. The wave generator 4 flexes the portion of the circular flexible externally toothed gear 3 where external teeth 3a are formed into an oval shape. The external teeth 3a at both ends in the direction of a major axis Lmax of the oval mesh with the corresponding internal teeth 2a of the circular rigid internally toothed gear 2.

A motor shaft or any other high-speed rotating input shaft is connected to the wave generator 4. When the wave generator 4 is rotated, the positions where the two gears 2 and 3 mesh with each other move in the circumferential direction, and relative rotation resulting from the difference in the number of teeth between the two gears 2 and 3 is produced therebetween. For example, the rigid internally toothed gear 2 is fixed so that it does not rotate, and the flexible externally toothed gear 3 is connected to a member on a load side. In this case, the rotation of reduced speed is delivered from the flexible externally toothed gear 3 and transferred to the member on the load side.

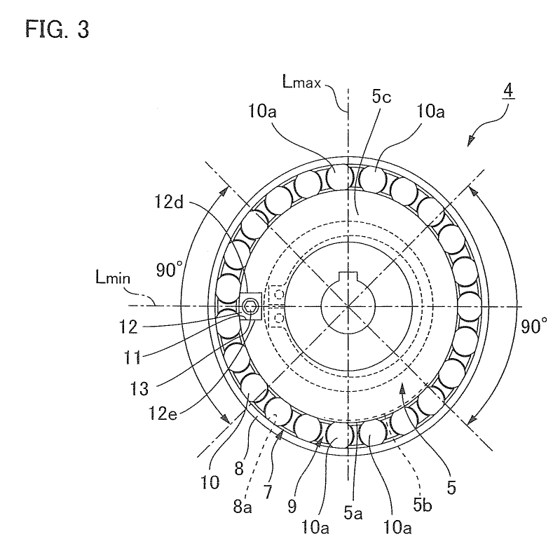

FIG. 3 is a front view showing the wave generator 4. The wave generator 4 will now be described with reference to FIGS. 1 and 3. The wave generator 4 includes a rigid cam plate 5 having an oval contour (rigid raceway member) and a wave bearing 7 (oval bearing) mounted on the outer periphery of the rigid cam plate 5. The wave bearing 7 has an oval raceway surface 5b formed along an oval outer peripheral surface 5a of the rigid cam plate 5. The wave bearing 7 further has a thin flexible raceway ring 8 that is flexible in the radial direction and disposed so that it concentrically surrounds the oval raceway surface 5b. The flexible raceway ring 8 has a circular initial shape, and the inner peripheral surface thereof forms a circular raceway surface 8a in the initial state. A plurality of balls 10 are rollably inserted into an race 9 formed between the oval raceway surface 5b and the circular raceway surface 8a of the flexible raceway ring 8, and the balls 10 inserted into the race 9 cause the circular flexible raceway ring 8 to flex into an oval shape.

The rigid cam plate 5 has a ball insertion hole 11 through which the balls 10 are inserted into the race 9. The ball insertion hole 11 is blocked with a plug 12 attached thereto. The plug 12 is fixed to the rigid cam plate 5 with a fastening bolt 13 or any other suitable fastener. The ball insertion hole 11 is formed in the rigid cam plate 5 in a position on a minor axis Lmin of the oval shape.

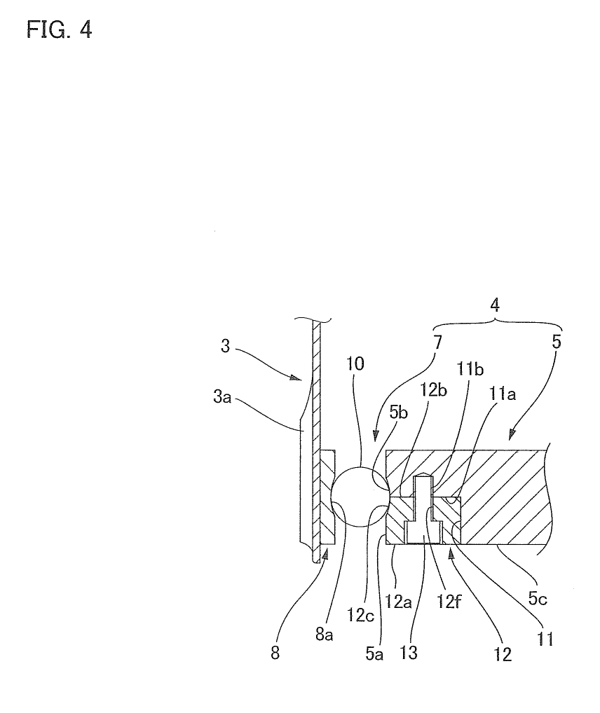

FIG. 4 is a partial cross-sectional view showing the portion where the ball insertion hole 11 is formed. The ball insertion hole 11 will be described with reference to FIGS. 3 and 4. The ball insertion hole 11 has a rectangular cross-sectional shape having a fixed width and extending along the radial direction of the rigid cam plate 5. The depth of the ball insertion hole 11, which starts from one end surface 5c of the rigid cam plate 5, is one-half the thickness of the rigid cam plate 5.

The plug 12 has a box-like shape as a whole that is complementary to the shape of the ball insertion hole 11. An outer end surface 12a of the plug 12 redefines the portion of the end surface 5c of the rigid cam plate 5 that is removed by forming the ball insertion hole 11. An inner end surface 12b of the plug 12 comes into intimate contact with a bottom surface 11 a of the ball insertion hole 11 in the rigid cam plate 5, and an raceway surface portion 12c for redefining the portion of the oval raceway surface 5b that is removed by forming the ball insertion hole 11 is formed at the corner of the inner end surface 12b that faces the race 9. Side surfaces 12d and 12e on both sides of the plug 12 are in intimate contact with left and right inner side surfaces of the ball insertion hole 11, respectively. Further, a bolt hole 12f is formed through the plug 12 from the outer end surface 12a thereof to the inner end surface 12b thereof, and a bolt hole 11b is formed from the bottom surface 11a of the ball insertion hole 11. The plug 12 is fixed to the rigid cam plate 5 by screwing the fastener bolt 13 into the bolt holes 12f and 11b.

In the thus configured wave gear device 1, the wave bearing 7 is fit in the flexible externally toothed gear 3 with the wave bearing 7 flexed by the rigid cam plate 5 into an oval shape, and the wave bearing 7 holds the flexible externally toothed gear 3 and the rigid cam plate 5, which is connected to the high-speed rotating input shaft, in such a way that they can rotate relative to each other. That is, when the balls 10 inserted into the space between the rigid cam plate 5 and the flexible raceway ring 8 roll along the raceway surface 5b of the rigid cam plate 5 and the raceway surface 8a of the flexible raceway ring 8, the rigid cam plate 5 and the flexible externally toothed gear 3 can smoothly rotate relative to each other with a small torque.

Since the rigid cam plate 5 flexes the wave bearing 7 into an oval shape, one or more balls 10a positioned at each end of the major axis Lmax of the oval shape are tightly sandwiched between the oval raceway surface 5b and the circular raceway surface 8a, come into point contact with the raceway surfaces, and roll therealong. The remaining balls 10 positioned in locations other than both ends of the major axis Lmax are held between the raceway surfaces 5b and 8a, where there is a gap and the balls can freely roll.

When a torque acts on the wave gear device 1, the largest load acts on the portions of the wave generator 4 that are positioned at both ends of the major axis Lmax of the rigid cam plate 5. In general, loads act on the portions within an angular range of 90 degrees in the circumferential direction centered on the major axis Lmax as shown in FIG. 3, and the loads gradually decrease as the distance from the major axis Lmax increases. Further, substantially no load acts on the portions of the wave generator 4 that are positioned at both ends of the minor axis Lmin, and the loads that act on the portions within an angular range of 90 degrees in the circumferential direction centered on the minor axis Lmin are very small.

The ball insertion hole 11 is located in the position on the minor axis Lmin of the oval shape on which substantially no load acts when a torque acts on the wave gear device 1. No ball 10 will therefore be pressed with a large force against the seam between the raceway surface portion 12c of the plug 12, which blocks the ball insertion hole 11, and the mating portion of the oval raceway surface 5b of the rigid cam plate 5. Flaking or any other similar problem will therefore not occur, whereby the service life of the bearing will not decrease.

When the wave generator 4 is assembled, the balls 10 can be inserted through the ball insertion hole 11. In the process of inserting the balls, it is necessary to forcibly insert the balls 10 while the other inserted balls 10 cause the circular flexible raceway ring 8 to flex into an oval shape. In this process, the deformation of the flexible raceway ring 8 resulting from the inserted balls 10 reduces the greatest width of the race and makes it difficult to insert the balls. Since the balls 10 are inserted through the ball insertion hole 11 in the present example, the balls 10 can be inserted more readily than in related art.

Further, since the ball insertion hole 11 is formed in a position on the minor axis where substantially no load acts, the oval raceway surface 5b or the circular raceway surface 8a is hardly scratched, for example, when the balls are inserted. A drawback of decrease in service life of the bearing resulting from scratches on the raceway surfaces produced, for example, when the balls are inserted will therefore not occur. Moreover, when a wrong number of balls are inserted in the assembly process, for example, reassembling can be more readily performed than in related art.

In the present example, the ball insertion hole 11 is formed in a position on the minor axis Lmin of the oval shape of the rigid cam plate 5. The ball insertion hole 11 may be formed in a portion where substantially no load or a very small load acts. That is, the ball insertion hole 11 can be formed in a portion within an angular range of 90 degrees in the circumferential direction centered on the minor axis Lmin, which covers the portion of the rigid cam plate 5 that is outside the load acting area.

### Second Embodiment

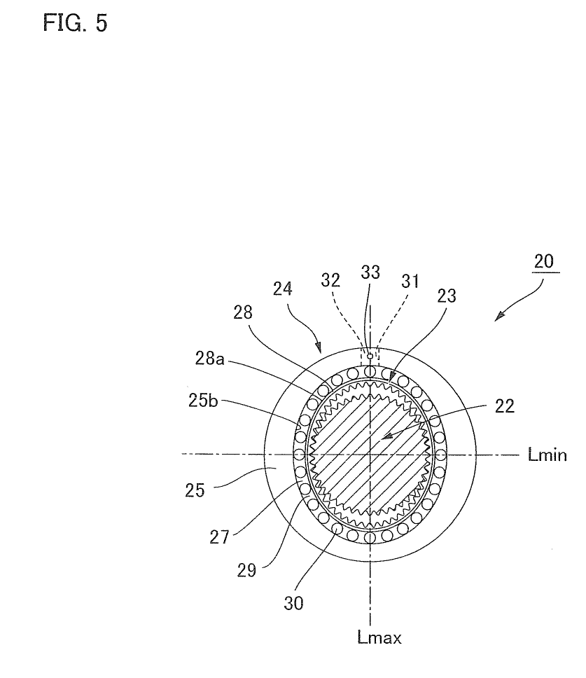

FIG. 5 is a descriptive diagram showing a wave gear device according to a second embodiment to which the present invention is applied. A wave gear device 20 has a rigid externally toothed gear 22 disposed in the innermost portion thereof. An annular flexible internally toothed gear 23 is disposed so as to concentrically surround the rigid externally toothed gear 22. An annular wave generator 24 having an oval inner peripheral surface is disposed so as to concentrically surround the flexible internally toothed gear 23.

The wave generator 24 includes an annular rigid cam plate 25 (rigid raceway member) and a wave bearing 27 disposed in the rigid cam plate 25. The outer ring of the wave bearing 27 is formed integrally with the rigid cam plate 25. That is, an oval raceway surface 25b of the wave bearing 27 is formed along an oval inner peripheral surface of the rigid cam plate 25. The inner ring of the wave bearing 27 is formed of a circular flexible raceway ring 28 that is flexible in the radial direction, and a circular raceway surface 28a is formed along a circular outer peripheral surface of the flexible raceway ring 28. A plurality of balls 30 are rollably inserted into an race 29 formed between the oval raceway surface 25b and the circular raceway surface 28a, and the inserted balls 30 cause the flexible raceway ring 28 to flex into an oval shape.

The thus configured wave generator 24 flexes the annular flexible internally toothed gear 23 disposed therein into an oval shape, and the inner teeth positioned at both ends of the minor axis Lmin of the oval shape of the flexible internally toothed gear 23 mesh with the corresponding outer teeth of the rigid externally toothed gear 22 disposed therein. For example, the wave generator 24 is fixed so that it does not rotate, and the rigid externally toothed gear 22 is rotated with a motor or any other rotating drive source. In this case, the positions where the two gears 22 and 23 mesh with each other move in the circumferential direction, and relative rotation according to the difference in the number of teeth between the two gears is produced therebetween. The rotation can be delivered from the flexible internally toothed gear 23.

When a torque acts on the thus configured wave gear device 20, large loads act on the portions of the wave generator 24 that correspond to the positions where the two gears 22 and 23 mesh with each other, that is, portions corresponding to both ends of the minor axis Lmin of the oval shape, whereas substantially no loads act on portions corresponding to both ends of the major axis Lmax of the oval shape. The relationship described above is the opposite of the relationship in the wave gear device 1 according to the first embodiment.

In the wave generator 24 of the wave gear device 20, a ball insertion hole 31 is formed in the rigid cam plate 25 in a position on the major axis Lmax. The ball insertion hole 31 is blocked with a plug 32. The ball insertion hole 31 can be formed through an end surface of the rigid cam plate 25, as in the case of the ball insertion hole 11 in the first embodiment. In the present example, the ball insertion hole 31 is a through hole having a circular cross-sectional shape and passing through the rigid cam plate 25 in the radial direction from the circular outer peripheral surface thereof to the circular raceway surface thereof. The plug 32, which has a cylindrical shape, is externally attached to the ball insertion hole 31 and fixed to the rigid cam plate 25 with a pin 33 or any other fastener. An raceway surface portion that redefines the portion of the oval raceway surface that is removed by forming the ball insertion hole 31 is formed on a front end surface of the plug 32.

In the thus configured wave gear device 20, the balls can also be readily inserted when the wave generator 24 is assembled. Further, any drawbacks resulting from the formation of the ball insertion hole, such as a decrease in service life of the bearing, will not occur, and no scratches will be formed on the raceway surfaces when the balls are inserted.

### Third Embodiment

The embodiments described above relate to an oval bearing by way of example of noncircular bearings. The present invention is also applicable to other noncircular bearings as well as oval bearings.

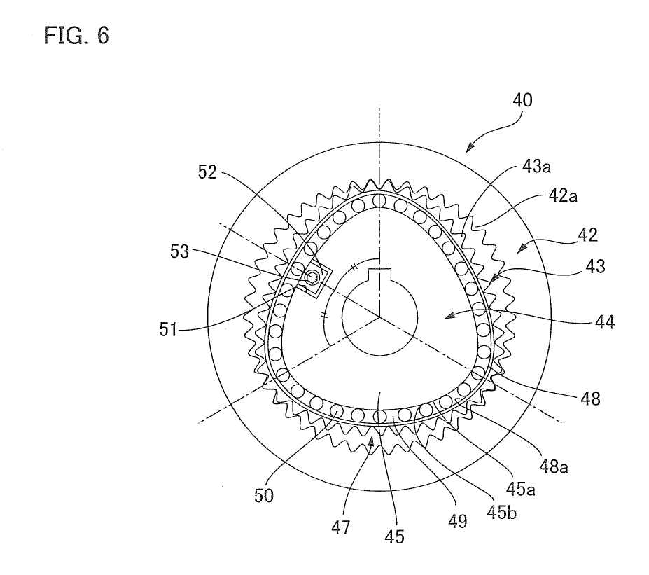

FIG. 6 is a descriptive diagram showing a wave gear device 40 according to a third embodiment. The wave gear device 40 includes a rigid internally toothed gear 42, a flexible externally toothed gear 43 disposed in the rigid internally toothed gear 42, and a wave generator 44 having a noncircular contour and fit in the flexible externally toothed gear 43. The wave generator 44 flexes the portion of the circular flexible externally toothed gear 43 where external teeth 43a are formed into a noncircular shape.

The wave generator 44 includes a rigid cam plate 45 (rigid raceway member) having a noncircular contour and a wave bearing 47 (noncircular bearing) mounted on the outer periphery of the rigid cam plate 45. The wave bearing 47 has a noncircular raceway surface 45b formed along a noncircular outer peripheral surface 45a of the rigid cam plate 45. The wave bearing 47 further includes a thin flexible raceway ring 48 that is flexible in the radial direction and disposed so that it concentrically surrounds the noncircular raceway surface 45b. The flexible raceway ring 48 has a circular initial shape (shape before being flexed), and the inner peripheral surface of the flexible raceway ring 48 forms a circular raceway surface 48a in the initial state. A plurality of balls 50 are rollably inserted into a race 49 formed between the noncircular raceway surface 45b and the annular raceway surface 48a of the flexible raceway ring 48.

The inserted balls 50 cause the flexible raceway ring 48 to flex in the radial direction and hence cause the circular raceway surface 48a thereof to flex into a shape similar to that of the noncircular raceway surface 45b. The noncircular shape of the noncircular raceway surface 45b is defined by a closed curve that can be inscribed in a perfect circle at evenly spaced multiple locations along the circumferential direction of the perfect circle. In the present example, the noncircular raceway surface 45b has a shape called a three-lobe curve and is defined by a closed curve inscribable in a perfect circle at evenly spaced three locations along the circumferential direction of the perfect circle. The noncircular shape of the noncircular raceway surface 45b can alternatively be defined by a closed curve inscribable in a perfect circle at evenly spaced four or more locations along the circumferential direction of the perfect circle.

The thus shaped wave generator 44 flexes the flexible externally toothed gear 43 into a shape that approximates a shape similar to the noncircular contour of the wave generator 44, and external teeth 43a mesh with internal teeth 42a in the three positions in the circumferential direction.

A motor shaft or any other high-speed rotating input shaft is connected to the wave generator 44. When the wave generator 44 is rotated, the positions where the two gears 42 and 43 mesh with each other move in the circumferential direction, and relative rotation resulting from the difference in the number of teeth between the two gears 42 and 43 is produced therebetween. For example, the rigid internally toothed gear 42 is fixed so that it does not rotate, and the flexible externally toothed gear 43 is connected to a member on a load side. In this case, the rotation of reduced speed is delivered from the flexible externally toothed gear 43 and transferred to the member on the load side. The difference in the number of teeth between the two gears 42 and 43 in this case is set at 3 n (n is a positive integer), typically set at 3.

The rigid cam plate 45 has a ball insertion hole 51 through which the balls 50 are inserted into the race 49. The ball insertion hole 51 is blocked with a plug 52 attached thereto. The plug 52 is fixed to the rigid cam plate 45 with a fastening bolt 53 or any other suitable fastener. The ball insertion hole 51 is positioned in the rigid cam plate 45 between two adjacent inscribed locations among the three inscribed locations where the noncircular contour of the wave generator 44 is inscribed in a perfect circle.

### Fourth Embodiment

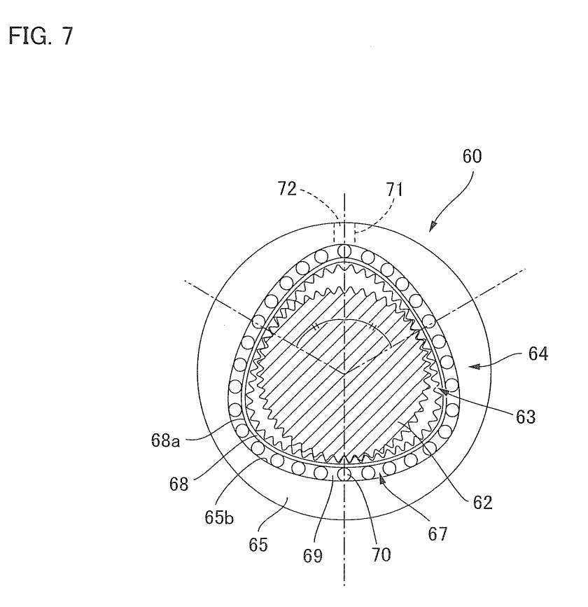

A wave generator 64 having a noncircular contour other than an oval contour can be used in a wave gear device 60 having a configuration in which a flexible internally toothed gear 63 is disposed outside a rigid externally toothed gear 62, as shown in FIG. 7. In this case, the noncircular contour of the wave generator 64 may be a closed curve circumscribed about a perfect circle at evenly spaced multiple locations along the circumferential direction of the perfect circle. For example, a closed curve circumscribed about a perfect circle at three locations can be used. A wave bearing 67 is disposed between the wave generator 64 and the flexible internally toothed gear 63 and holds them in such a way that they can rotate relative to each other.

The wave generator 64 includes a rigid cam plate 65 (rigid raceway member) having a noncircular contour and the wave bearing 67 (noncircular bearing) mounted on the inner peripheral surface of the rigid cam plate 65. The wave bearing 67 has a noncircular raceway surface 65b formed along the noncircular inner peripheral surface of the rigid cam plate 65. The wave bearing 67 further includes a thin flexible raceway ring 68 that is flexible in the radial direction and disposed inside the noncircular raceway surface 65b and concentrically therewith. The flexible raceway ring 68 has a circular initial shape (shape before being flexed), and the outer peripheral surface of the flexible raceway ring 68 forms a circular raceway surface 68a in the initial state. A plurality of balls 70 are rollably inserted into a race 69 formed between the noncircular raceway surface 65b and the circular raceway surface 68a of the flexible raceway ring 68. An insertion hole 71 through which the balls 70 are inserted is disposed in a position offset from any locations where the noncircular contour of the wave generator 64 is circumscribed about the perfect circle. The insertion hole 71 is blocked with a plug 72.

### Other Embodiments

In any of the embodiments described above, the ball insertion hole is provided at a single location but can be provided at multiple locations in some cases. In this case, an extra ball insertion hole is also desirably located in a position offset from any of the locations where a noncircular raceway surface of a wave bearing is inscribed in or circumscribed about a perfect circle.

Further, in any of the embodiments described above, a noncircular bearing is used as a wave bearing in a wave generator of a wave gear device. Any of the noncircular bearings according to the present invention is not necessarily used in a wave bearing in a wave generator but can be used in other devices.

Moreover, in any of the embodiments described above, the wave bearing is a ball bearing but can alternatively be a bearing including rollers or any other rolling elements other than balls.

### DESCRIPTION OF SYMBOLS

1, 20, 40, 60 Wave gear device

2, 42 Rigid internally toothed gear

22, 62 Rigid externally toothed gear

2a, 42a Internal teeth

3, 43 Flexible externally toothed gear

23, 63 Flexible internally toothed gear

3a, 43a External teeth

4, 24, 44, 64 Wave generator

5, 25, 45, 65 Rigid cam plate

5a, 45a Outer peripheral surface

5b, 25b, 45b, 65b Raceway surface

5c End surface

7, 27, 47, 67 Wave bearing

8, 28, 48, 68 Flexible raceway ring

8a, 28a, 48a, 68a Circular raceway surface

9, 29, 49, 69 Race

10, 10a, 30, 50, 70 Ball

11, 31, 51, 71 Ball insertion hole

11a Bottom surface

11b Bolt hole

12, 32, 52, 72 Plug

12a Outer end surface

12b Inner end surface

12c Raceway surface portion

12d, 12e Side surface

12f Bolt hole

13, 53 Fastening bolt

1. A noncircular bearing (7, 27, 47, 67) characterized in comprising:
a rigid raceway member (5, 25, 45, 65) having a noncircular raceway surface;
a flexible raceway ring (8, 28, 48, 68) that is flexible in a radial direction and has, before flexed, a circular raceway surface (8a, 28a, 48a, 68a);
a plurality of rolling elements (10, 30, 50, 70) rollably inserted into an race (9, 29, 49, 69) formed between the noncircular raceway surface (5b, 25b, 45b, 65b) and the circular raceway surface (8a, 28a, 48a, 68a);
an insertion hole (11, 31, 51, 71) formed in the rigid raceway member (5, 25, 45, 65) to insert the rolling elements (10, 30, 50, 70) into the race (9, 29, 49, 69); and
a plug (12, 32, 52, 72) that blocks the insertion hole (11, 31, 51, 71),
wherein the flexible raceway ring (8, 28, 48, 68) is flexed by the rolling elements (10, 30, 50, 70) inserted into the race (9, 29, 49, 69) and the circular raceway surface (8a, 28a, 48a, 68a) is flexed into a shape similar to a shape of the noncircular raceway surface, and
the noncircular shape of the noncircular raceway surface is defined by a closed curve inscribable in or circumscribable about a perfect circle at evenly spaced multiple locations along a circumferential direction of the perfect circle.

2. The noncircular bearing (7, 47) according to claim 1,
characterized in that the noncircular raceway surface (5b, 45b) is formed along an outer peripheral surface of the rigid raceway member (5, 45),
the circular raceway surface (8a, 48a) is formed along an inner peripheral surface of the flexible raceway ring (8, 48),
the noncircular shape of the noncircular raceway surface (5b, 45b) is defined by a closed curve inscribable in a perfect circle, and
the insertion hole (11, 51) is formed in a position offset in the circumferential direction from an inscribed position where the closed curve that defines the noncircular raceway surface (5b, 45b) is inscribed in the perfect circle.

3. The noncircular bearing (7) according to claim 2,
characterized in that the noncircular raceway surface is an oval raceway surface, and
the insertion hole (11) is formed in a position offset in the circumferential direction from a major axis (Lmax) of an oval that defines the oval raceway surface (5b).

4. The noncircular bearing (7) according to claim 3,
characterized in that the insertion hole (11) is formed in a position within a range of 90 degrees in the circumferential direction centered on a minor axis (Lmin) of the oval that defines the oval raceway surface (5b).

5. The noncircular bearing (7) according to claim 3,
characterized in that the insertion hole (11) is formed in a position on a minor axis (Lmin) of the oval that defines the oval raceway surface (5b).

6. The noncircular bearing (27, 67) according to claim 1,
characterized in that the noncircular raceway surface (25b, 65b) is formed along an inner peripheral surface of the rigid raceway member (25, 65),
the circular raceway surface (28a, 68a) is formed along an outer peripheral surface of the flexible raceway ring (28, 68),
the noncircular shape of the noncircular raceway surface (25b, 65b) is defined by a closed curve circumscribable about a perfect circle, and
the insertion hole (31) is formed in a position offset in the circumferential direction from a circumscribed position where the closed curve that defines the noncircular raceway surface (25b, 65b) is circumscribed about the perfect circle.

7. The noncircular bearing (27) according to claim 6,
characterized in that the noncircular raceway surface is an oval raceway surface, and
the insertion hole (31) is formed in a position offset in the circumferential direction from a minor axis (Lmin) of an oval that defines the oval raceway surface (25b).

8. The noncircular bearing (27) according to claim 6,
characterized in that the insertion hole (31) is formed in a position within a range of 90 degrees in the circumferential direction centered on a major axis (Lmax) of the oval that defines an oval raceway surface (25b).

9. The noncircular bearing (27) according to claim 6,
characterized in that the insertion hole (31) is formed in a position on a major axis (Lmax) of an oval that defines the oval raceway surface (25b).

10. A wave generator (4, 24, 44, 64) of a wave gear device (1, 20, 40, 60), which flexes a flexible gear (3, 23, 43, 63) into a noncircular shape to partially mesh with a rigid gear (2, 22, 42, 62) and moves a position where the two gears (2, 3, 22, 23, 42, 43, 62, 63) mesh with each other in a circumferential direction so that relative rotation according to the difference in the number of teeth between the two gears is produced therebetween, the wave generator (4, 24, 44, 64) characterized in comprising:
a rigid cam plate (5, 25, 45, 65) and a wave bearing (7, 27, 47, 67),
wherein the wave bearing (7, 27, 47, 67) includes
a noncircular raceway surface (5b,, 25b, 45b, 65b) formed on the rigid cam plate (5, 25, 45, 65),
a flexible raceway ring (8, 28, 48, 68) that is flexible in a radial direction and has an raceway surface (8a, 28a, 48a, 68a) having a circular initial shape before flexed,
a plurality of rolling elements (10, 30, 50, 70) rollably inserted into a race (9, 29, 49, 69) formed between the noncircular raceway surface (5b, 25b, 45b, 65b) and the circular raceway surface (8a, 28a, 48a, 68a),
an insertion hole (11, 31, 51, 71) formed in the rigid raceway member (5, 25, 45, 65) to insert the rolling elements (10, 30, 50, 70) into the race (9, 29, 49, 69), and
a plug (12, 32, 52, 72) that blocks the insertion hole (11, 31, 51, 71); wherein
the flexible raceway ring (8, 24, 48, 68) is flexed by the rolling elements (10, 30, 50, 70) inserted into the race (9, 29, 49, 69) and the circular raceway surface (8a, 28a, 48a, 68a) is flexed into a shape similar to the shape of the noncircular raceway surface, and
the noncircular shape of the noncircular raceway surface (5b, 25b, 45b, 65b) is defined by a closed curve inscribable in or circumscribable about a perfect circle at evenly spaced multiple locations along a circumferential direction of the perfect circle.

11. The wave generator (4, 44) according to claim 10,
characterized in that the rigid gear is a rigid internally toothed gear (2, 42),
the flexible gear is a flexible externally toothed gear (3, 43),
the wave generator (4, 44) is disposed inside the flexible externally toothed gear (3, 43),
the noncircular raceway surface (5b,, 45b) is formed along an outer peripheral surface of the rigid cam plate (5, 45),
the circular raceway surface (8a, 48a) is formed along an inner peripheral surface of the flexible raceway ring (8, 48),
the noncircular shape of the noncircular raceway surface is a shape defined by a closed curve inscribable in a perfect circle, and
the insertion hole (11, 51) is formed in a position offset in the circumferential direction from an inscribed position where the closed curve that defines the noncircular raceway surface (5b, 45b) is inscribed in the perfect circle.

12. The wave generator (4) according to claim 11,
characterized in that the noncircular raceway surface is an oval raceway surface (5b), and
the insertion hole (11) is formed in a position offset in the circumferential direction from a major axis (Lmax) of a race that defines the oval raceway surface (5b).

13. The wave generator (4) according to claim 11,
characterized in that the insertion hole (11) is formed in a position within a range of 90 degrees in the circumferential direction centered on a minor axis (Lmin) of an oval that defines the oval raceway surface (5b).

14. The wave generator (4) according to claim 11,
characterized in that the insertion hole (11) is formed in a position on a minor axis (Lmin) of an oval that defines the oval raceway surface (5b).

15. The wave generator (24, 64) according to claim 10,
characterized in that the rigid gear is a rigid externally toothed gear (22, 62),
the flexible gear is a flexible internally toothed gear (23, 63),
the flexible internally toothed gear (23, 63) is disposed inside the wave generator (24, 64),
the noncircular raceway surface (25b, 65b) is formed along an inner peripheral surface of the rigid cam plate (25, 65),
the circular raceway surface (28a, 68a) is formed along an outer peripheral surface of the flexible raceway ring (28, 68),
the noncircular shape of the noncircular raceway surface (25b, 65b) is defined by a closed curve circumscribable about a perfect circle, and
the insertion hole (31, 71) is formed in a position offset in the circumferential direction from a circumscribed position where the closed curve that defines the noncircular raceway surface (5b, 25b) is circumscribed about the perfect circle.

16. The wave generator (24) according to claim 15,
characterized in that the noncircular raceway surface is an oval raceway surface, and
the insertion hole (31) is formed in a position offset in the circumferential direction from a minor axis (Lmin) of a race that defines the oval raceway surface (25b).

17. The wave generator (24) according to claim 15,
characterized in that the insertion hole (31) is formed in a position within a range of 90 degrees in the circumferential direction centered on a major axis (Lmax) of an oval that defines the oval raceway surface (25b).

18. The wave generator (24) according to claim 15,
characterized in that the insertion hole (31) is formed in a position on a major axis (Lmax) of an oval that defines the oval raceway surface (25b).

19. A wave gear device (1, 40) comprising: a rigid internally toothed gear (2, 42); a flexible externally toothed gear (3, 43) disposed concentrically with the rigid internally toothed gear (2, 42); and a wave generator (4, 44) that flexes the flexible externally toothed gear (3, 43) into an oval shape to allow the flexible externally toothed gear (3, 43) to partially mesh with the rigid internally toothed gear (2, 42) and moves a position where the two gears (2, 3, 42, 43) mesh with each other in a circumferential direction to produce relative rotation between the two gears in accordance with the difference in the number of teeth between the two gears,
characterized in that the wave generator (4, 44) is the wave generator according to any of claims 10 to 14.

20. A wave gear device (20, 60) comprising: a rigid externally toothed gear (22, 62); a flexible internally toothed gear (23, 63) disposed concentrically with the rigid externally toothed gear (22, 62); and a wave generator (24, 64) that flexes the flexible internally toothed gear (23, 63) into an oval shape to allow the flexible internally toothed gear (23, 63) to partially mesh with the rigid externally toothed gear (22, 62) and moves a position where the two gears (22, 23, 62, 63) mesh with each other in a circumferential direction to produce relative rotation between the two gears in accordance with the difference in the number of teeth between the two gears,
characterized in that the wave generator (24, 64) is the wave generator according to any of claims 15 to 19.
